(19) United States
(12) Patent Application Publication
(10) Pub. No.: US 2009/0003911 A1
(43) Pub. Date: Jan. 1, 2009

(54) Children's copying machine

(76) Inventors: Judith Bender, Fairfield, CT (US); Jon Soriano, Sandy Hook, CT (US); Darryl Hudeck, Highlands Ranch, CO (US)

Correspondence Address: GRIMES & BATTERSBY, LLP, 488 MAIN AVENUE, THIRD FLOOR, NORWALK, CT, 06851, US

(21) Appl. No.: 12/154,291

(22) Filed: May 21, 2008

Related U.S. Application Data
(60) Provisional application No. 60/931,161, filed on May 21, 2007.

(51) Int. Cl. G03G 15/00

(52) U.S. Cl. 399/405

(57) ABSTRACT

The present invention comprises a children's copying machine for copying two- and three-dimensional objects. The copy machine includes a slidable art tray for receiving two dimensional objects and or creative drawing on an erasable surface. The art tray surface is supported on springs and depressible for further receiving three dimensional objects. Special effects are provided such as image storage into memory, combining of selected images for printing, warping of images and overlay functions. A spin tray is further incorporated into the art tray for providing rotational motion to objects during the copying process.

### CROSS REFERENCES TO RELATED APPLICATIONS

This application claims priority benefit of a U.S. Provisional Application, Ser. No. 60/931,161 filed in the United States Patent and Trademark Office on May 21, 2007, and entitled “Toy Copying Device”, directed to the same subject matter as the instant application, and filed by the same inventors.

### STATEMENT REGARDING FEDERALLY SPONSORED RESEARCH

Not Applicable

### REFERENCE TO APPENDIX

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### REFERENCE TO APPENDIX

Not Applicable

### BACKGROUND OF THE INVENTION

A. Field of the Invention

The present invention relates to creative toys for children, and more particularly, to a children's copying machine. The word ‘toy’ as used in this application means nothing more than ‘something a child plays with’. The sometimes implied connotation of a ‘toy’ being a mere replica of a real world object does not apply here, as the instant invention is a fully functional copier. It is however primarily designed for the use and enjoyment of children.

B. Prior Art

Copy machines have long been known in the industry. However, such devices are targeted at adult or professional users. A children's copier does not currently exist, and office-use models are not appropriate for use by children. The shortcomings of commercial copiers include: safety concerns (e.g., a glass copying surface), portability (too heavy to carry), complexity of instructions and operations, and the inability to support copying of 3D objects.

### BRIEF SUMMARY OF THE INVENTION

It is an object of the present invention to provide a feature rich fully functioning copy machine intended primarily for creative use by children.

A further object of the present invention is to provide a toy copy machine having a design characterized by a child-friendly package.

Yet still another object of the present invention is to provide a toy copy machine having a rugged design.

But another object of the present invention is to provide a toy copy machine that is easy to handle by children.

Yet another object of the present invention is to provide a toy copy machine that is simple to understand and operate.

Still a further object of the present invention is to provide a toy copy machine that even very young children may use.

Another object of the present invention is to provide a toy copy machine designed to operate under adverse conditions without malfunction or hazard.

To the accomplishment of these and other objects, the present invention, in brief summary, comprises an imaging mechanism housed within a rugged, sturdy case, wherein the imaging mechanism includes a copying mechanism and an output device, both of which are powered by a power source and controlled by a system computer. Copying is accomplished by means of a line scanner situated adjacent to an imaging bed upon which said objects may be placed, which line scanner produces a digital image of said objects. The digital image is sent to the output device which, in the preferred embodiment is a color ink jet printer.

### BRIEF DESCRIPTION OF THE DRAWINGS

FIG. 1 is a front perspective view of the children's copy machine of the present invention with the art tray in an open position;

FIG. 2 is a front perspective view of the children's copy machine of the present invention with the art tray in a closed position;

FIG. 3 is a front perspective view of the children's copy machine of the present invention with the art tray in a closed position and the ears and top cover in open positions;

FIG. 4 is a front plan view of the left ear controls;

FIG. 5 is a front plan view of the right ear controls;

FIG. 6 is a front perspective view of the children's copy machine of the present invention with the art tray in a closed position and a copy being discharged from the paper path;

FIG. 7 is a rear perspective view of the children's copy machine of the present invention with paper tray cover in an open position;

FIG. 8 is a top perspective view of the spin art tray;

FIG. 9 is a top plan view of the spin art tray with no motion effects;

FIG. 10 is a top plan view of the spin art tray with slow motion effects;

FIG. 11 is a top plan view of the spin art tray with fast motion effects;

FIG. 12 is a top perspective detailed view of the art tray and paper storage tray; and

FIG. 13 is a schematic drawing of the children's copier.

### DETAILED DESCRIPTION OF THE PREFERRED EMBODIMENT

Referring to the drawings, the toy copy machine of the present invention is illustrated and is referred to generally by reference number 10. The copy machine 10 comprises an imaging mechanism 100, power source 104, system computer 108, and output device 112. These systems reside in a single, portable case 116. The copy machine 10 allows the user to place objects such as paper, photographs, or small solid objects such as dice inside the imaging area 120 of the device 10 and then produce a printed paper image of these objects by means of the copying mechanism 124.

In the preferred embodiment, the copying mechanism 124 comprises a flat imaging bed 128, adjacent to which is a line scanner 132 consisting of multiple wavelength LED illumination sources 136 and photodiode detectors 140 arranged to be subject to light reflected by the objects to be imaged. The copying mechanism 124 operates under the control of the system computer 108, and is actuated by a single push button 42, 44 which initiates the imaging process.

The line scanner 132 is driven across the imaging bed 128 by a linear motion servomechanism 148. As the line scanner 132 traverses the imaging bed 128, the LED illumination sources 136 illuminate the objects on the imaging bed 128, while the photodiode detectors 140 generate an electrical signal which is digitally sampled and manipulated by the system computer 108 to create a digital data image representation of the objects. This image data is sent then to a printing mechanism 152. The printing mechanism 152 consists of a paper storage area 156, a paper delivery and positioning mechanism 160, and a printhead 164. During printing, the printhead 164 repeatedly traverses a linear path while the paper positioning mechanism 160 advances the paper with each pass of the printhead 164. An ink dispenser 168 discharges the ink droplets onto the paper in accordance with the image data, thereby reproducing an image of the original objects on the paper.

The power source 104 consists of a series of rechargable batteries 172 and power conversion electronics 176 suited to meet the requirements of the dependant systems. The batteries 172 are sized to provide a nominal one hundred cycles of operation before recharging is required. In the preferred embodiment, charging of the on-board batteries 172 is accomplished with an external, line-powered charger. The charger includes safety features to prevent injury to users, even in the event of misuse or abuse.

It should be appreciated that the copying mechanism 124 described herein is only one of a number of different solutions contemplated for copying the two- and three-dimensional objects. There are a number of image sensors and printing apparatuses that would work equally effectively. The primary concern is that such technologies be reliable and rugged enough to withstand the abuse of a children's toy. For example, while the prototype uses a line scanner 132, a CCD (charge coupled device) camera could be used as a means to reduce cost and size. The current inkjet print method may be replaced by a thermal transfer printhead, or other method of printing. Storage of individual sheets of paper may be replaced by bulk storage of paper on a replaceable roll. Printing would occur just prior to the paper leaving the roll, and the paper may be cut to any length by tearing off against a serrated edge.

The ability to image 3-D objects, and a software method of image manipulation such as color inversion, stretching or other distortions will be included. Image distortion by moving the subject (paper or object) with respect to the image-capture area (blurring) is understood as a creative mechanism enabled by this device.

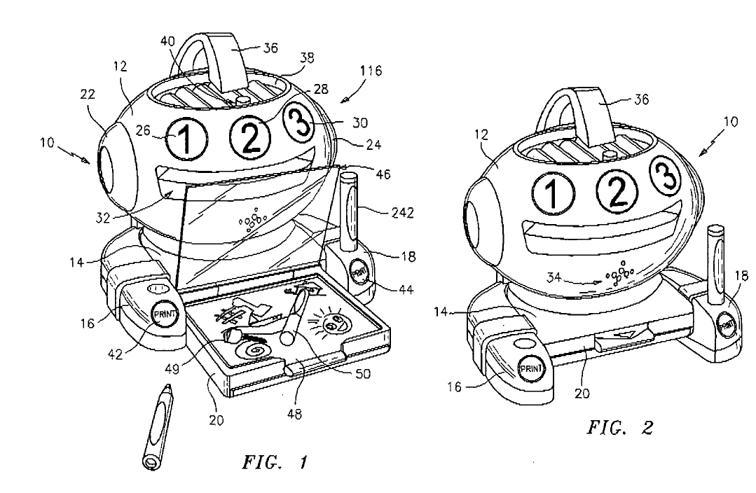

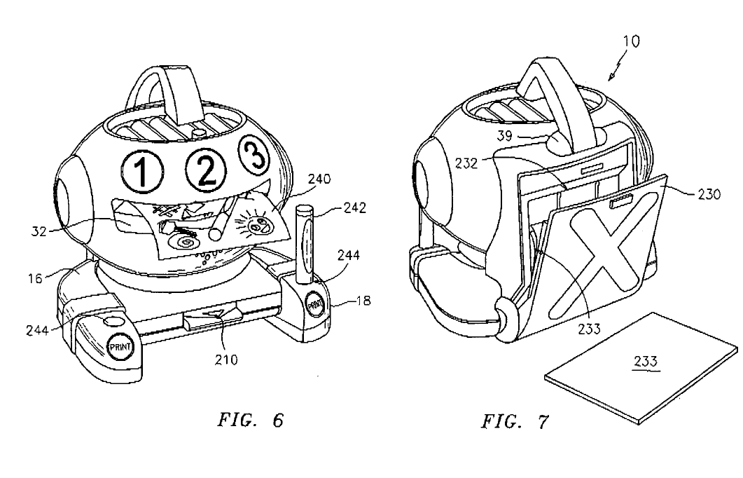

Referring now to FIG. 1 the present invention children's copier 10 is shown. The copier 10 includes a head 12 sitting upon a body 14 and further comprising a left arm 16 and a right arm 18. Disposed within the body 14 is a slideable art tray 20 which slides between an open position (as shown) and a closed position as shown in FIG. 2. Further disposed on the head 12 is a left ear 22 and a right ear 24. Located across the top of the head 12 is a left eye 26, a middle eye 28, and a right eye 30. Each of the eyes 26, 28, & 30 is a memory button which stores into a selected memory location a copy of the current contents of the art tray 20. The images stored in the memory locations can be used with special functions contained in the ears 22, 24 as described further below. A mouth 32 is disposed upon the head 12 just below the eyes 26, 28 and 30. The mouth 32 is actually the paper output path of the copier 10 as can be seen in FIG. 6. Just below the mouth 32 is a speaker 34 for producing computer generated audio cues to assist children in the use and enjoyment of the copy machine 10.

On top of the head 12 is a hingeable cover 38. The cover is secured to the head 12 by a latch 40. A handle 36 attaches the cover 38 to a hinge 39 as shown in FIG. 7. The handle 36 is also used to lift and carry the portable copier 10 from one location to another.

Located on either side of the body 14 is a left arm 16 and a right arm 18. Each arm has a single print button 42, 44 easily available to a child. When either print button 42, 44 is depressed the copier 10 begins to copy whatever images and/or three-dimensional objects are contained in the art tray 20.

The art tray 20 includes a clear cover plate 46 which hingedly opens and closes to provide access to an erasable drawing surface 48. A child can draw or markup the drawing surface 48 with the markers 242 provided. The surface 48 is conducive to being erased and reused. A child may also place three-dimensional objects such as a key 49 or a marker 50 onto the drawing surface 48. The drawing surface 48 is mounted upon springs (not shown) so that three dimensional objects maybe depressed when the clear cover plate 46 is closed. The clear cover plate 46 allows the imaging mechanism 100 to copy the contents in the art tray 20 without any optical interference, and yet at the same time provide physical security to those three-dimensional objects which are thicker than the empty space between the drawing surface 48 and the cover plate 46 when it is in the closed position (not shown). The clear cover plate 46 folds down and lies flat on top of the art tray 20 so that the art tray may slide back into the copier body 14 to begin the imaging process.

Referring now to FIG. 2 the copier 10 is shown with the art tray 20 in the closed position.

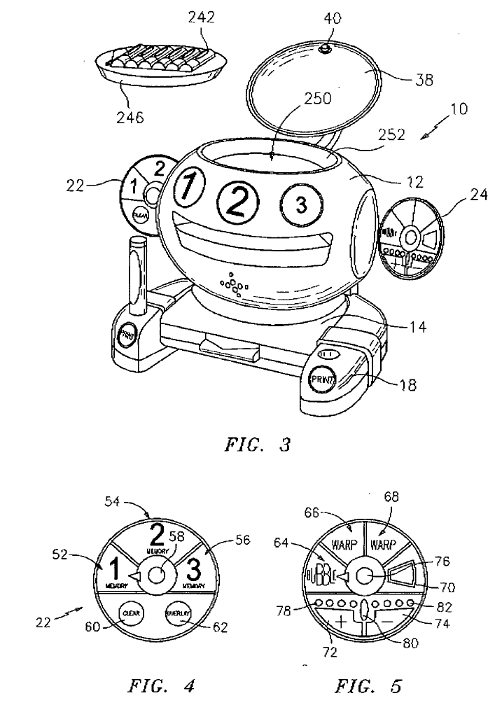

Referring now to FIG. 3 the copier 10 is shown with the cover 38 in the open position. A marker tray 246 has been removed from the top access hole 250 and it can be seen that the tray 246 is holding several different colored markers 242. The marker tray 246 has a tapered edge for sitting in the tapered collar 252 of the access hole 250.

It is also through the top access hole 250 that the internal components of the printer 152 and copier 124 maybe serviced. Normal maintenance functions such as replenishing ink or toner, clearing paper jams, and/or removing/replacing print drums and/or other components are performed through the access hole 250.

Also shown in FIG. 3, the left ear 22 and the right ear 24 are shown in open positions. Each of the ears 22, 24 contain specialized copy/memory/print functions as will be described below. The ears 22, 24 are hingedly attached to the head 12.

Referring now to FIG. 4 the left ear 22 is shown. The left ear 22 contains a rotatable memory selector 58 which can select any one of memory location ONE 52, memory location TWO 54, or memory location THREE 56. Also contained in the left ear 22 is a clear button 60 and an overlay button 62. When the clear button 60 is depressed the current memory location 52, 54, 56 selected by the memory selector 58 is erased. In this manner a child can erase any one of or all three memory locations. When the overlay button 62 is depressed the image in the memory location 52, 54, 56 selected by the memory selector 58, is overlaid electronically on the image currently in the scan memory location. The image in the scan memory location is the last or current image the imaging mechanism retrieved from the scanning the art tray 20. Thus a child by use of the memory buttons 26, 28, and 30 and the controls in the left ear 22, can store a previously scanned image into a memory location 26, 28, 30 and thereafter combined it with another memory location through use of the memory selector 58 and the overlay button 62. The overlay button 62 can be used to combine images stored in memory locations 26, 28, 30 with each other or with the currently scanned image from the art tray 20.

Now referring to FIG. 5 the right ear 24 controls are shown. A special effects selector 76 is rotatable between special effects such as bubble 64, warp ONE 66, warp TWO 68, and border 70. Each of these special effects maybe applied to any image which is selected for printing regardless of whether it is a stored image in memory 26, 28, 30 or the currently scanned image from the art tray 20. Also contained on the right ear 24, are magnification controls 72, 74, 80 and indicators 78, 80, 82. A child can enlarge an image by pressing the magnification button 72 or shrink the image by pressing the shrink button 74. As the child pushes these buttons 72, 74 a single LED lights up along the continuous linear array of LEDs from LED 78 to LED 82. The center LED 80 is also a push button input used to reset the magnification function back to zero. This LED 80 is also illuminated when the magnification function is at zero. Thus the center LED 80 is also depressible and functions as a switch input to reset the magnification function to zero.

Now referring to FIG. 6 the copier 10 is shown. A paper output copy 240 can be seen as it is discharged from the mouth 32 of the copy machine 10. This is the paper discharge path. Also, shown in each arm 16, 18 is a marker hole 244 for holding a marker 242. After a child is done with any one of his or her color markers 242, they maybe stored in either one of the marker holes 244.

Now referring to FIG. 7 a rear prospective view of the copier 10 is shown. A paper tray cover 230 is hingedly attached to the rear of the copier 10. The paper tray cover 230 opens to an inclined position as shown so that paper 233 maybe inserted into the vertical paper tray 232. When the copier begins its print cycle it retrieves a clean sheet of paper 233 from the paper tray 232 as is known in the art.

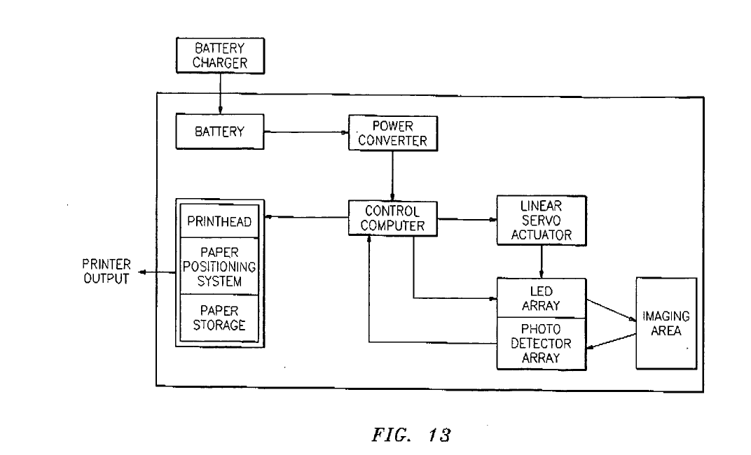

Now referring to FIG. 8 a spin art tray 200 is shown. The spin art tray 200 consists of a plastic rectangular frame 202 which secures a clear rectangular plate 204. Mounted within the rectangular plate 204 is the circular spin frame 206 which houses the circular spin plate 208. This spin art tray 200 sits on top of the art tray 20 as shown in FIG. 12. A child places printed material and/or paints or draws directly onto the spin plate 208. The spin tray 200 is then placed into the art tray 20 as shown in FIG. 12. The art tray 20 is then slid into the closed position inside the copier 10 as shown in FIGS. 2, 3, 6. The child then presses one of the buttons which causes image scanning to commence. The child may push a print button 42, 44 or he or she may push one of the memory buttons 26, 28, 30. As the scanning commences the child begins to rotate the spin wheel 210 (see FIG. 6) which causes the spin plate 208 to rotate in a circular manner. The child may vary both the speed and the direction of the spin wheel 210 which causes a like effect on the rotation of the spin plate 208.

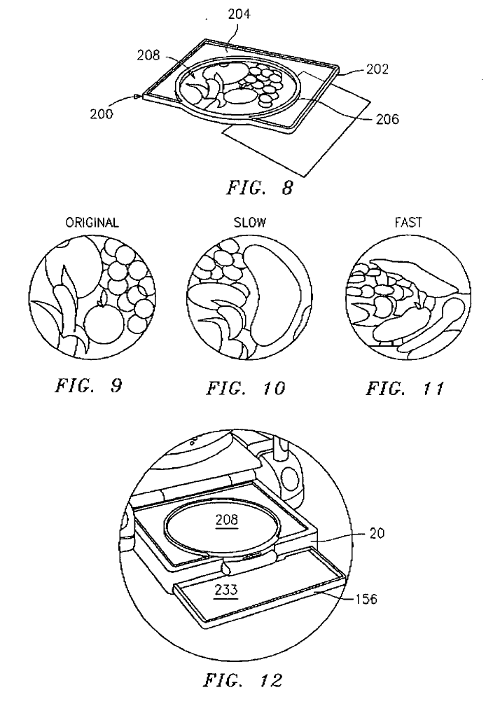

FIGS. 9, 10 and 11, show the various effects which can be caused by the spin plate 208. FIG. 9 shows the original image with no spinning effect. FIG. 10 shows the effect of a slow spin during the imaging process. FIG. 11 shows the effects of a fast spin in the imaging process.

Referring now to FIG. 12 a slideable draw 156 is shown. The draw 156 slides out from the bottom of the art tray 20 for convenient storage of paper 233.

Referring now to FIG. 13 a schematic diagram of the copier 10 is shown.

Having thus described the invention with particular reference to the preferred forms thereof, it will be obvious that various changes and modifications can be made therein without departing from the spirit and scope of the present invention as defined by the appended claims.

We claim:

1. A copy machine operable by a child for copying two- and three-dimensional objects comprising:
an imaging mechanism having an art tray slidably attached thereto;
said art tray slidably operable between an open and closed position;
said art tray having an erasable drawing surface accessible to said child in said open position;
said drawing surface accessible in said open position for receiving two dimensional images;
wherein said child opens said art tray and either draws and or inserts two dimensional images onto said drawing surface, and subsequently closes said tray, and said copier prints an image of the contents of said art tray.

2. The copy machine of claim 1, in which said art tray further comprises:
springs upon which said drawing surface is mounted; and
a clear plastic cover mounted on said art tray and operable between a closed and open position;
wherein said child may place a three-dimensional object on said drawing surface and close said cover whereby said springs allow said drawing surface to depress and accommodate said three-dimensional object within the art tray for copying.

3. The copy machine of claim 2, further comprising
a spin tray mountable on said art tray and slidably moving in union with said art tray between said open and closed positions.

4. The copy machine of claim 3, and further comprising
said spin tray is rotatable by a spin wheel while said spin tray is in a closed position.

5. The copy machine of claim 3, and further comprising
at least one electronic memory for receiving and storing an image from said imaging mechanism.

6. The copy machine of claim 3, and further comprising
overlay means;
whereby said overlay means electronically combines said electronic memory with a current image from said art tray and prints said combined image.

7. The copy machine of claim 3, and further comprising
special effects means;
including at least one of a bubble effect, a warping effect, and or a border effect whereby said special effects means electronically alters said current image from said art tray and prints said altered image.

8. The copy machine of claim 3, and further comprising
magnification means;
whereby said magnification means electronically alters said current image from said art tray and prints said altered image.

9. The copy machine of claim 3, and further comprising
an access port for allowing access to said copier internal components;
a hingedly mounted access port cover operable between a closed and open position;
a removable storage tray mounted in said access port and beneath said cover in said closed position.

10. The copy machine of claim 3, and further comprising
a first and a second control panel hingedly mounted on opposing sides of said copy machine;
said panels each rotatably movable between an open and closed position;
said panels each having controls accessible only when said panel is in an open position;
said first panel having controls for storing images into electronic memory; and
said second panel having controls for applying special effect means to said electronic memory.

11. The copy machine of claim 3, and further comprising
a paper storage tray slidably attached to a lower surface of said art tray.
